(19) United States
(12) Patent Application Publication
(10) Pub. No.: US 2025/0383914 A1
(43) Pub. Date: Dec. 18, 2025

(54) DISTRIBUTED PIPELINE-PARALLEL LLM FINE-TUNING METHOD FOR HETEROGENEOUS GPU

(71) Applicants: Zhejiang New Internet Exchange Center Co., Ltd., Hangzhou (CN); Sichuan University, Chengdu City (CN)

(72) Inventors: Shicong ZHANG, Hangzhou (CN); Mingjie TANG, Chengdu City (CN); Jingqi TIAN, Chengdu City (CN); Zhengmao YE, Chengdu City (CN); Dengchun LI, Chengdu City (CN); Zetao HU, Chengdu City (CN); Lei DUAN, Chengdu City (CN); Jie ZUO, Chengdu City (CN); Chenhui GU, Hangzhou (CN)

(21) Appl. No.: 18/917,847

(22) Filed: Oct. 16, 2024

(30) Foreign Application Priority Data
Jun. 16, 2024 (CN) 202410772174.3

(51) Int. Cl. G06F 9/48; G06F 9/54

(52) U.S. Cl. CPC G06F 9/4881; G06F 9/54; G06F 2209/543

(57) ABSTRACT

This application relates to the technical field of natural language processing, and provides a distributed pipeline-parallel LLM fine-tuning method for heterogeneous GPUs. A plurality of LoRA models are fine-tuned simultaneously based on a multi-job fine-tuning system; each LoRA model is partitioned into a plurality of parts distributed on a corresponding number of GPUs, and the GPUs are sorted. A job configuration module generates a plurality of jobs according to a user request, and divides each job into a plurality of training batches; a dynamic job scheduler generates a scheduling scheme based on a training batch sequence of each job and a dynamic scheduling strategy; and the scheduling scheme is sent to a multi-job training module on each corresponding GPU according to a positive sequence of the GPUs, to train all the LoRA models.

### CROSS REFERENCE TO RELATED APPLICATION

This patent application claims the benefit and priority of Chinese Patent Application No. 202410772174.3, filed with the China National Intellectual Property Administration on Jun. 16, 2024, the disclosure of which is incorporated by reference herein in its entirety as part of the present application.

### TECHNICAL FIELD

The present disclosure relates to the technical field of natural language processing and relates to a large language model (LLM) fine-tuning method, in particular, to a distributed pipeline-parallel LLM fine-tuning method for heterogeneous graphics processing units (GPUs).

### BACKGROUND

In the field of natural language processing, fine-tuning LLMs is crucial for adapting a pre-trained generic model to specific jobs or domains. Traditional full fine-tuning methods update all model parameters. However, due to the vast number of LLM parameters and the complexities of fine-tuning jobs, this approach may be cumbersome and computationally intensive. As a result, optimizing GPU memory and computing resources during fine-tuning, particularly through parameter-efficient fine-tuning techniques, has become a key research focus.

Existing methods, such as low-rank adaptation (LoRA), offer a parameter-efficient fine-tuning approach by adjusting only a part of parameters to achieve model specialization and domain adaptation, thereby maintaining fine-tuning effectiveness while reducing computing resource demands. However, when dealing with multi-job fine-tuning, especially on large-scale LLMs, a plurality of challenges persist, including the efficient allocation and utilization of computing resources, and enhancing the overall efficiency of the training and fine-tuning process through dynamic job scheduling and distributed computation optimization algorithms.

Currently, research on LLM fine-tuning optimization includes approaches like S-LoRA and other systems. The S-LoRA system is designed to optimize LLM efficiency in service scenarios. The core concept involves using heterogeneous batch processing to manage different LoRA adapters, combined with efficient management of key-value (KV) caches and other methods to improve system throughput. By sharing a pre-trained model, the system effectively manages computing resources while serving numerous LoRA adapters. Although focusing on improving LLM efficiency in service scenarios and system throughput through batch processing and resource management, the S-LoRA system does not fully address the training scenario in the fine-tuning process, particularly for multi-job and large model fine-tuning, and performance still requires further improvement.

Therefore, current LLM fine-tuning technologies mainly face the following problems: (1) The complexity of multi-job fine-tuning is not fully considered, or there is a lack of efficient job scheduling algorithms and resource allocation strategies. This results in limited flexibility and intelligence in resource allocation and job scheduling; (2) Due to the absence of dynamic resource allocation and job scheduling mechanisms, or due to hardware configuration mismatches, some GPUs may be idle while others are overloaded. This fails to effectively address the issue of unbalanced computing resource utilization in a multi-GPU environment. (3) Failure to design an efficient model synchronization strategy suitable for a multi-GPU environment, or insufficient optimization of the model convergence speed may lead to inconsistent model convergence across different GPUs, which may negatively impact the fine-tuning results.

### SUMMARY

To address the shortcomings of the prior art, the present disclosure provides a distributed pipeline-parallel LLM fine-tuning method for heterogeneous GPUs. This approach enhances the efficiency and effectiveness of fine-tuning large-scale pre-trained language models for specific jobs, maximizes the utilization of computing resources, and reduces training costs.

The inventive concept of the present disclosure is as follows: (1) For multi-LoRA job fine-tuning in a single-GPU environment, a more efficient gradient descent method and job scheduling strategy are developed to maximize the utilization of a single GPU, improve job throughput and turnover rates; and the model fine-tuning process is optimized to fully leverage GPU memory and computing power, enhancing training speed and model performance. (2) For LoRA model parallel fine-tuning in a multi-machine multi-GPU environment, efficient model partitioning and vector parallelism technologies are designed to fully utilize the computing power and memory of multiple GPUs, thereby achieving efficient parallel fine-tuning. This approach addresses issues of computing load imbalance and communication overhead in pipeline parallelism by designing new strategies for overlapping computation and communication to improve training efficiency and ensure model convergence. (3) The present disclosure further proposes two scheduling optimization algorithms for multi-LoRA fine-tuning jobs: The first is an early stopping estimation algorithm, which accurately predicts job execution time and releases GPU resources in advance to enhance overall system throughput. The second is a job scheduling optimization algorithm, which efficiently optimizes batch fusion strategies during multi-job execution to reduce idle time in the computing process and ensures efficient utilization and fair management of resources.

According to the distributed pipeline-parallel LLM fine-tuning method for heterogeneous GPUs, a plurality of LoRA models are fine-tuned simultaneously based on a multi-job fine-tuning system; each LoRA model is partitioned into a plurality of parts distributed on a corresponding number of GPUs, and the GPUs are sorted; the multi-job fine-tuning system includes a job configuration module, a profiler, a dynamic job scheduler, and multi-job training modules distributed on the plurality of GPUs; each multi-job training module is configured to fine-tune a corresponding part of each LoRA model; and
the distributed pipeline-parallel LLM fine-tuning method includes the following steps:
S1: generating, by the job configuration module, a plurality of jobs according to a user request, and dividing each job into a plurality of training batches;
S2: configuring, by the profiler, a hyperparameter for each job;
S3: generating, by the dynamic job scheduler, a scheduling scheme based on a training batch sequence of each job and a dynamic scheduling strategy;
S4: sending the scheduling scheme to a multi-job training module on a first GPU according to a positive sequence of the GPUs; training, by the multi-job training module, all the LoRA models according to training batches contained in the scheduling scheme; transmitting a training result to a multi-job training module on a next GPU; repeating the above operations until a last GPU; determining a loss function based on a training result output by the last GPU, and feeding back the training result and the loss function to the profiler; and backpropagating the loss function according to a reverse sequence of the GPUs, and optimizing a parameter of the corresponding part of the LoRA model on each GPU; and
S5: performing, by the profiler, precision analysis according to the training result and the loss function, and determining whether all the jobs meet a training requirement; and if yes, ending the program; or otherwise, feeding back a precision analysis result to the dynamic job scheduler, and returning to the step S3.

The LoRA model is selected from LLaMA-7B, LLAMA-13B, ChatGLM2-6B, LLAMA2-7B, LLAMA2-13B and the like. The LoRA model may be partitioned according to different dimensions, such as by layer or by parameters. In a preferred implementation, for example, the LoRA model is partitioned into a head (HEAD), a middle (MID) and a tail (TAIL). The HEAD and the TAIL are distributed on two GPUs, while whether the MID needs to be further partitioned may be determined according to the size, to be distributed on more than one GPU.

In the above step S1, the user request includes a job configuration (that is, a hyperparameter configuration of the model), training data, and a scheduling objective. The scheduling objective includes minimizing waiting time, reducing turnaround time, maximizing throughput, maximizing precision, and performing scheduling in sequence.

In the step S3, the dynamic job scheduler sorts jobs in each batch based on job lengths, and performs job symbol padding in the scheduling scheme on jobs with same or similar job lengths in the same batch. In this way, the dynamic job scheduler employs a near-optimal method to minimize the impact of padding symbols on training throughput. This means the dynamic job scheduler can effectively handle input sequences of varying lengths, thereby reducing the waste of computing resources caused by padding symbols.

The dynamic scheduling strategy includes:
(1) a without early stopping strategy: executing according to a job sequence;
(2) an early stopping strategy: executing according to a job sequence at the beginning; during training, ending a job with precision deterioration in advance based on a changing trend of the precision analysis result from the profiler, and advancing a subsequent job;
(3) an early stopping strategy with prediction: first, generating the scheduling scheme based on data of more than one batch of all the jobs, executing the step S4 to perform a pre-test to obtain a prediction result, and feeding back the prediction result to the profiler; performing, by the profiler, precision analysis according to the prediction result, to generate a subsequent job scheduling scheme; and during subsequent training, ending a job with precision deterioration in advance based on a changing trend of the precision analysis result from the profiler, and advancing a subsequent job.

According to the scheduling objective in the user request, one of the strategies (1), (2) and (3) is selected to generate a scheduling job. For example, if the scheduling objective is to minimize waiting time, reduce turnaround time, and maximize throughput, the dynamic job scheduler automatically selects the strategy (2) or (3) according to the prediction result. If the scheduling objective is to execute a series of jobs in sequence, the dynamic job scheduler automatically selects the strategy (1). The dynamic job scheduler can effectively manage system resources and improve the overall system efficiency. The intelligent scheduling strategies ensure optimal allocation and utilization of system resources among all the jobs. Notably, a memory usage estimation model is implemented for the early stopping strategy with prediction. This allows the scheduler to adaptively adjust job scheduling based on current resource usage and job requirements, optimizing memory utilization and preventing memory overflow. Consequently, the scheduler achieves multi-objective optimization. The objectives are to reduce waiting and turnaround time, increase throughput, and maintain job execution priority and fairness. This means high-priority jobs are given precedence, while the principle of first-come, first-served is upheld.

In the step S4, the multi-job training module fuses training data of the plurality of jobs into a training set; and the plurality of LoRA models share one pre-training model in each iteration.

Given that an input sequence of an i^{th} job is xᵢ, output data is hᵢ. A fusion input matrix is expressed as X=Fusion (x₁, . . . , xₙ).The fusion input matrix is separately multiplied by a pre-training weight and a weight of each LoRA model, and results are added together to generate a final output H. A complete calculation formula is as follows:

$$H = Concat ( {h}_{1} , … , {h}_{n} ) = {W}_{0} X + [ Δ {W}_{1} {x}_{1} , … , Δ {W}_{n} {x}_{n} ] = {W}_{0} X + [ {B}_{1} {A}_{1} {x}_{1} , … , {B}_{n} {A}_{n} {x}_{n} ]$$

W₀∈R^{d×k} represents the shared pre-training weight, and d and k represent rows and columns of the matrix, ΔWᵢ=BᵢAᵢ represents a weight of an LoRA model trained in the i^{th} job, and Bᵢ∈R^{d×r}^{ᵢ} and Aᵢ∈R^{r}^{ᵢ}^{×k} are each a low rank decomposition matrix, with a rank rᵢ«min(d,k).

In the step S5, the profiler performs statistical analysis on a loss function value obtained after each batch of training for each job, and may further fit the loss function value. In addition, according to the training result, the profiler performs statistical analysis on and fits an accuracy rate obtained after each batch of training for each job. The precision analysis result includes changes in the loss function value and the accuracy rate with respect to the number of iterations.

Compared with the prior art, the distributed pipeline-parallel LLM fine-tuning method for heterogeneous GPUs provided in the present disclosure offers the following beneficial effects:
(1) The multi-job scheduling system in the present disclosure enables efficient GPU memory management and optimization strategies, including memory allocation, sharing mechanisms, and dynamic scheduling. This allows for concurrent execution of more fine-tuning jobs, improves GPU memory utilization, and enhances overall system performance.
(2) The present disclosure employs a fine model partitioning and allocation strategy, an optimized pipeline path, and a job load balancing strategy. These approaches more effectively utilize computing resources in a multi-machine multi-GPU environment, enhancing the overall efficiency of the fine-tuning process and reducing resource waste.
(3) The present disclosure designs an intelligent job scheduling mechanism and a dynamic early stopping strategy that adjust job execution sequences and priorities in real time based on performance metrics and system load. This approach reduces unnecessary computation overhead and maximizes system throughput and resource utilization. By optimizing algorithms and resource management, the present disclosure ensures the performance and quality of the fine-tuning model while maintaining fine-tuning efficiency, thereby improving the performance and application effect on specific jobs.

In summary, the technical solutions of the present disclosure lead to a more efficient, intelligent, and high-quality large-scale model fine-tuning process.

### BRIEF DESCRIPTION OF THE DRAWINGS

FIG. 1 is a multi-GPU model partitioning strategy in an LoRA fine-tuning scenario;

FIGS. 2A-2C iare schematic diagrams of the principle of different pipeline parallelism;

FIG. 3 is a schematic diagram of the principle of a multi-job scheduling system;

FIG. 4 is a schematic diagram of job scheduling;

FIG. 5 is a schematic diagram of an example of adaptive job scheduling;

FIGS. 6A-6B are schematic diagrams of the principles of traditional LoRA model training (a) and multi-job training (m-LoRA model training);

FIG. 7 is a schematic flowchart of a distributed pipeline-parallel LLM fine-tuning method for heterogeneous GPUs according to an embodiment of the present disclosure;

FIGS. 8A-8C show throughput of LLMs in different fine-tuning methods, where Alpaca-Seq and Alpaca-Parallel are both Alpaca-LoRA methods (see Eric Wang, Alpaca-lora, https://github.com/tloen/alpaca-lora, 2023); Alpaca-Seq trains models in sequence on a single GPU; Alpaca-Parallel trains a plurality of models simultaneously on a single GPU; ASPEN represents the experimental results of the present disclosure on a single GPU; FIG. 8A shows a throughput comparison of different models; FIG. 8B shows a throughput comparison of different parameters and model versions of the same model; and FIG. 8C shows a throughput comparison of different hardware; and

FIGS. 9A-9D show GPU memory usage of Alpaca-LoRA and ASPEN methods using NVIDIA A100 of 80 GB, where a batch size indicates a job quantity in a same batch, and OOM indicates out of memory.

### DETAILED DESCRIPTION OF THE EMBODIMENTS

The specific implementations of the present disclosure are described below to facilitate those skilled in the art to understand the present disclosure, but it should be clear that the present disclosure is not limited to the scope of the specific implementations. Various obvious changes made by those of ordinary skill in the art within the spirit and scope of the present disclosure defined by the appended claims should fall within the protection scope of the present disclosure.

### Embodiment

The purpose of the present disclosure is to explore methods for reducing the demand for computing resources while maintaining fine-tuning effectiveness, effectively allocating and utilizing computing resources across different hardware environments, and enhancing the overall efficiency of the training and fine-tuning process through dynamic job scheduling and distributed computation optimization algorithms.

The distributed pipeline-parallel LLM fine-tuning method for heterogeneous GPUs provided in the present disclosure is explained in detail through the embodiments.

### (I) Fine-Tuning Optimization Based on Pipeline Parallelism

In large model fine-tuning scenarios (a computing device includes GPUs and CPUs), a major challenge is that the model size may be large and exceed the memory capacity of a single GPU. As a result, it becomes necessary to partition and fine-tune the LoRA model across a plurality of GPUs.

Two key factors need to be considered in fine-tuning across a plurality of GPUs. First is whether the GPUs are of the same type, and second is how the GPUs are connected. This implementation outlines two scenarios: a fine-tuning scenario where all GPUs are of the same type, and a fine-tuning scenario where GPUs of different types are connected via Peripheral Component Interconnect Express (PCIe). The goal of this embodiment is to explore how to enhance computational efficiency during the fine-tuning process through model partitioning and pipeline parallelism technology.

Model partitioning involves partitioning an LLM into smaller parts that can be distributed across a plurality of compute nodes, such as GPUs. This approach allows each node to handle only a part of the model, thereby reducing the memory and computing resource requirements on any single node. Model partitioning may be performed in various dimensions, such as by layer or by parameter, with each method offering unique advantages and limitations.

Pipeline parallelism is a specialized parallel computing method that enables different parts (or layers) of a model to process different data simultaneously across a plurality of compute nodes.

Combining model partitioning with pipeline parallelism allows for the handling of LLMs but introduces new challenges, such as efficiently synchronizing and coordinating computations between different nodes and minimizing latency caused by data transfer and waiting. Addressing these challenges is crucial for achieving efficient fine-tuning training and inference for LLMs. In pipeline parallel processing, low utilization of computing resources is a significant issue. At any given time, typically only one computing device is performing a job, while others remain idle. Ignoring communication time, if there are N computing devices, the total time utilization is only 1/N. As the number of computing devices increases, the utilization of each device decreases further. To improve the utilization of computing devices, it is necessary to assign jobs to currently idle devices. This phenomenon, where downstream devices can work only after waiting for a long time while upstream devices complete computation, is known as a “Bubble”. Additionally, the sequential execution of computation and communication can also lead to resource waste. When intermediate computation results are transmitted forward and gradients are backpropagated between different devices, no computing device is performing a computation job. Therefore, both the computation and communication processes need to be carefully designed to enhance device utilization. Moreover, the way of partitioning the model into layers has an important effect on the computing performance. Due to the need to assign different layers of the model to different computing devices, different partitioning strategies may lead to significant differences in performance. Therefore, how to effectively partition the model is also a key factor affecting the pipeline-parallel processing performance.

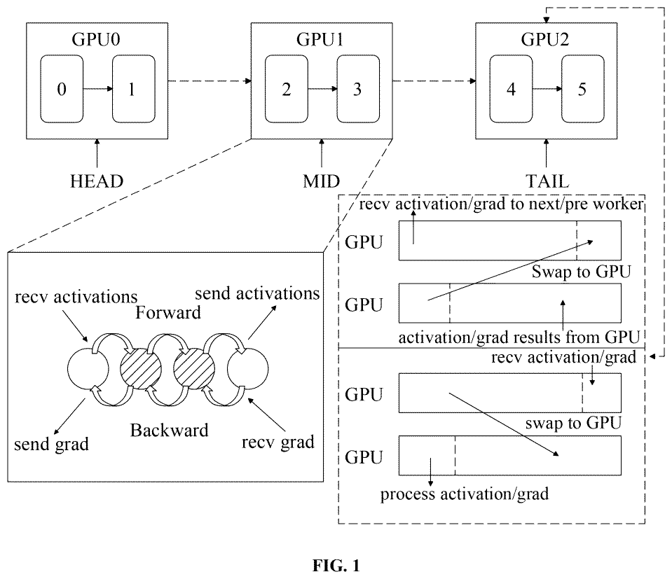

This embodiment uses a layer-by-layer partitioning approach and adjusts the model partitioning strategy based on the load elasticity of different GPUs. As shown in FIG. 1, in this embodiment, the LoRA model is partitioned into three parts: the HEAD, the MID, and the TAIL. The HEAD and TAIL are distributed across two GPUs, referred to as the first GPU (GPU0) and the last GPU (GPU2) that forward propagation passes through during job training. Whether the MID needs to be further partitioned may be determined based on the size and the MID is distributed across one or more GPUs (GPU1). As shown in FIG. 1, on a computing node on which the GPU is located, the CPU receives the information propagated forward or backward, and then sends the information to the GPU for processing, and a processing result of the GPU is then propagated through the CPU.

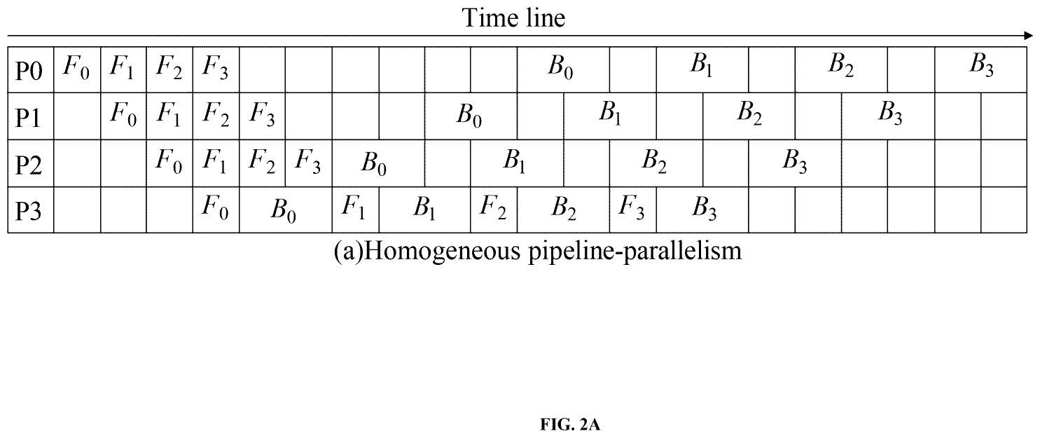

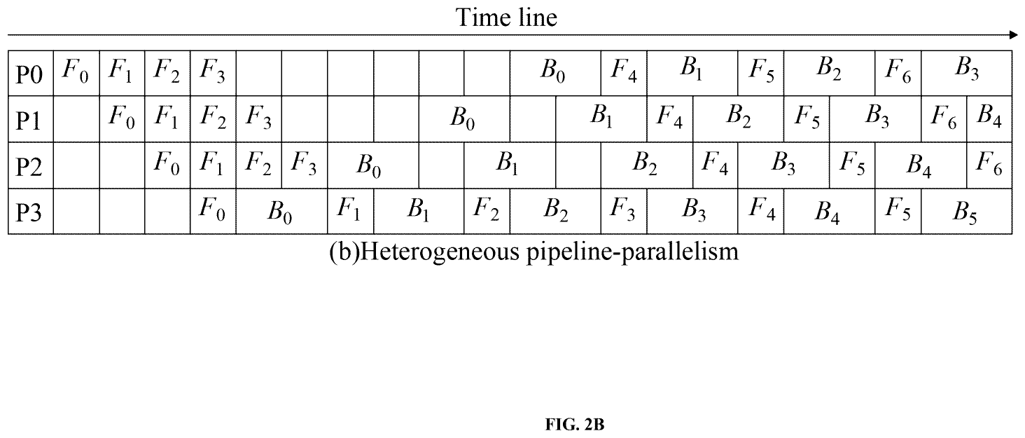

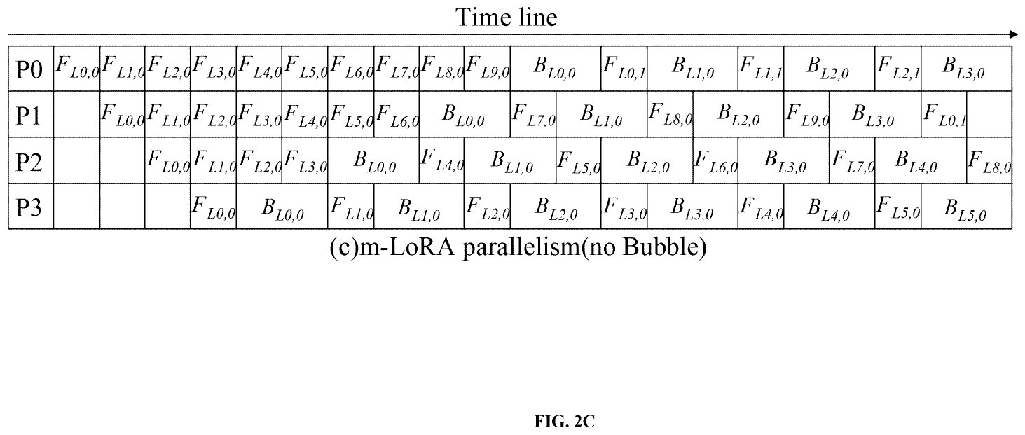

FIGS. 2A-2C show computation pipeline optimization for model fine-tuning in both homogeneous and heterogeneous GPU scenarios.

In the homogeneous GPU scenario, according to the traditional pipeline-parallel computing method, a plurality of job batches pass through each computing device in sequence to train different parts of the model.

In the heterogeneous GPU scenario, according to the traditional pipeline-parallel computing method, the jobs are grouped into a plurality of batches. The first batch of jobs passes through each computing device in sequence to train different parts of the model. After training is completed for all jobs in the first batch, the second and third batches of jobs are trained in sequence.

However, in the pipeline-parallel (m-LoRA pipeline-parallel) approach of this embodiment, input data is divided into a plurality of micro-batches that sequentially pass through different parts of the model located on different GPUs. When a batch of data passes through a part of the model, the batch of data is immediately transferred to a next part, and the GPU corresponding to the previous part starts processing a next batch of data simultaneously. This method can significantly improve the utilization of computing resources and enhance the overall processing speed. As shown in FIGS. 2A-2C, F indicates forward propagation, B indicates backward propagation. In FIG. 2A and FIG. 2B, F0-F3 indicate the forward propagation of the first training batch, and F4-F6 indicate the forward propagation of the second batch. In FIG. 2C, FL0,0-FL3,0 indicate the forward propagation of the first batch; FL4,0-FL7,0 indicate the forward propagation of the second batch; FL8,0, FL9,0, FL0,1, FL1,1 indicate the forward propagation of the third batches; FL2,1 indicates the forward propagation of the fourth training batch. The subscript of B corresponding to the subscript of F indicates the backward propagation of the corresponding same batch. On the same computing device, jobs are processed sequentially, with a preference given to backward propagation.

Therefore, compared to homogeneous and heterogeneous pipeline-parallel methods, the m-LoRA parallel method provided in the present disclosure can eliminate “Bubbles” and significantly improve the utilization of computing resources.

### (II) Multi-Job Scheduling System

The multi-job scheduling system provided in this embodiment enables the simultaneous training of multiple LoRA models (m-LoRA models).

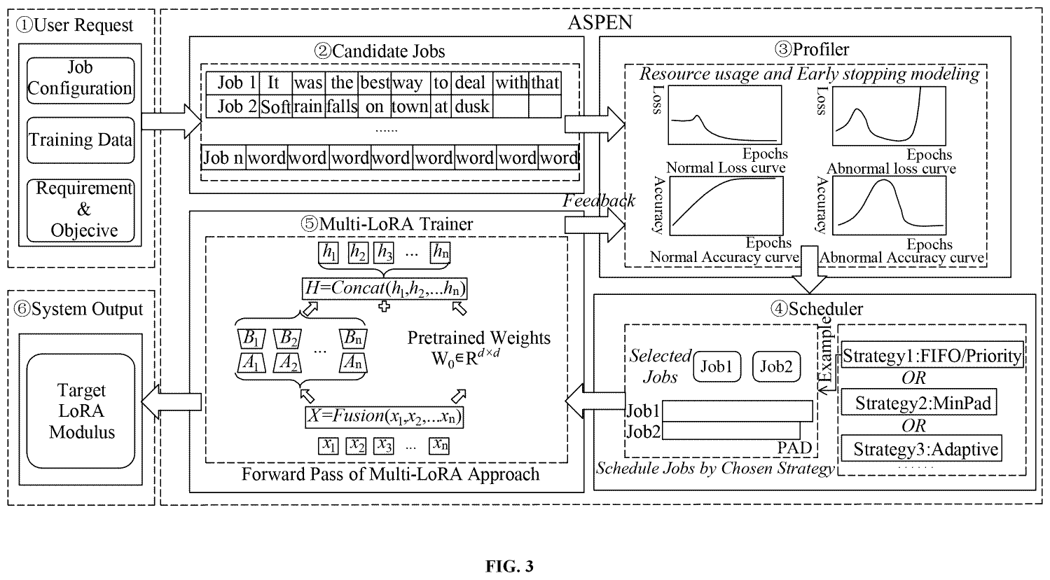

As shown in FIG. 3, a multi-job fine-tuning system provided in this embodiment includes a job configuration module, a profiler, a dynamic job scheduler, and multi-job training modules. The number of multi-job training modules matches the number of LORA model partitions, which are distributed across the corresponding GPUs. The job configuration module, the profiler, and the dynamic job scheduler may be provided on the first GPU.

As shown in FIG. 3, a user submits a request to the multi-job scheduling system, providing a job configuration (that is, a hyperparameter configuration of the model), training data, and a scheduling objective which may include minimizing wait time, reducing turnaround time, maximizing throughput, and performing scheduling in sequence. The job configuration module generates a plurality of candidate jobs (JOB) based on the information and the profiler configures an estimated basic hyperparameter for each job during system initialization. Once the system is initialized, the dynamic job scheduler selects some jobs from the candidate jobs, selects the most appropriate strategy, aligns the jobs and the strategy with the user-defined scheduling objective, and implements adaptive job scheduling. The m-LoRA model is then trained using the multi-job training module.

### 1. Job Configuration Module

The job configuration module is configured to generate a plurality of jobs according to the user request, and divide each job into a plurality of training batches.

The job configuration module divides the training data into a plurality of jobs (Job₁, Job₂, . . . , and Jobₙ) according to the user request. Then, each job is partitioned based on the set training batches.

### 2. Profiler

The profiler is configured to configure the estimated basic hyperparameter for each job during system initialization, and distribute the hyperparameter to the m-LoRA model on each GPU for initialization.

During the training process, after training of the last batch of jobs is completed, the profiler performs statistical analysis on a received loss function value obtained after each batch of training for each job, to obtain a change trend of the loss value with respect to the number of iterations. The profiler further fits the loss value to predict the change trend of the loss value with respect to the number of iterations.

In addition, the profiler performs statistical analysis on an accuracy rate obtained after each batch of training for each job based on a received training result, to obtain a change trend of the accuracy rate with respect to the number of iterations. The profiler further fits the accuracy rate to predict the change trend of the accuracy rate with respect to the number of iterations.

Therefore, the precision analysis result includes changes in the loss function value and accuracy rate with respect to the number of iterations.

When the loss function value or accuracy rate stabilizes, it is determined that the m-LoRA model has converged. The model convergence condition may alternatively be that the loss function value falls below a predefined threshold. Alternatively, whether the m-LoRA model converges may be determined according to whether the number of iterations reaches a set upper limit. When the model converges, the training objective (that is, the above scheduling objective) is achieved.

### 3. Dynamic Job Scheduler

The dynamic job scheduler is a key component in the multi-job scheduling system, and is configured to collect job indicators and accurately estimate model performance and resource utilization.

The dynamic job scheduler is configured to fuse a plurality of jobs based on a dynamic scheduling strategy, to generate a scheduling scheme, and send the scheduling scheme to the multi-job training modules.

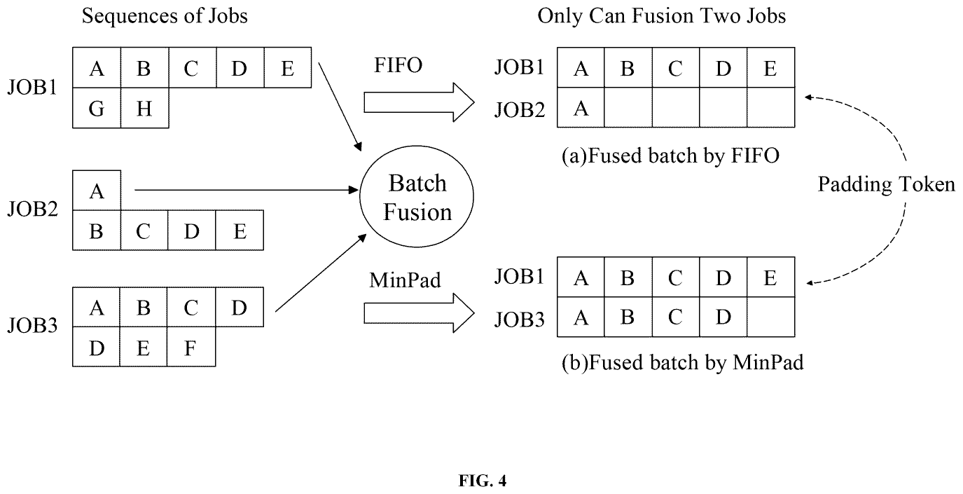

The dynamic job scheduler sorts jobs in each batch based on job lengths, and performs job symbol padding in the scheduling scheme on jobs with same or similar job lengths in the same batch. In this way, the dynamic job scheduler employs a near-optimal method to minimize the impact of padding symbols on training throughput. This means the dynamic job scheduler can effectively handle input sequences of varying lengths, thereby reducing the waste of computing resources caused by padding symbols. As shown in FIG. 4, the traditional scheduling method uses a first-in-first-out strategy, padding the scheduling scheme with job symbols and fusing the two jobs JOB1 and JOB2. In this embodiment, job fusion is performed based on the minimum difference in the number of padding symbols between jobs. Comparing JOB1, JOB2, and JOB3, the lengths of each batch for JOB1 and JOB3 are the closest, so the two jobs are fused.

The dynamic scheduling strategy includes:
(1) a without early stopping strategy: executing according to a job sequence;
(2) an early stopping strategy: executing according to a job sequence at the beginning; during training, ending a job with precision deterioration in advance based on a changing trend of the precision analysis result from the profiler, and advancing a subsequent job, where precision deterioration includes the loss function value increasing or the accuracy rate decreasing; and
(3) an early stopping strategy with prediction: first, generating the scheduling scheme based on data of more than one batch of all the jobs, executing the step S4 to perform a pre-test to obtain a prediction result, and feeding back the prediction result to the profiler; performing, by the profiler, precision analysis according to the prediction result, to generate a subsequent job scheduling scheme; and during subsequent training, ending a job with precision deterioration in advance based on a changing trend of the precision analysis result from the profiler, and advancing a subsequent job.

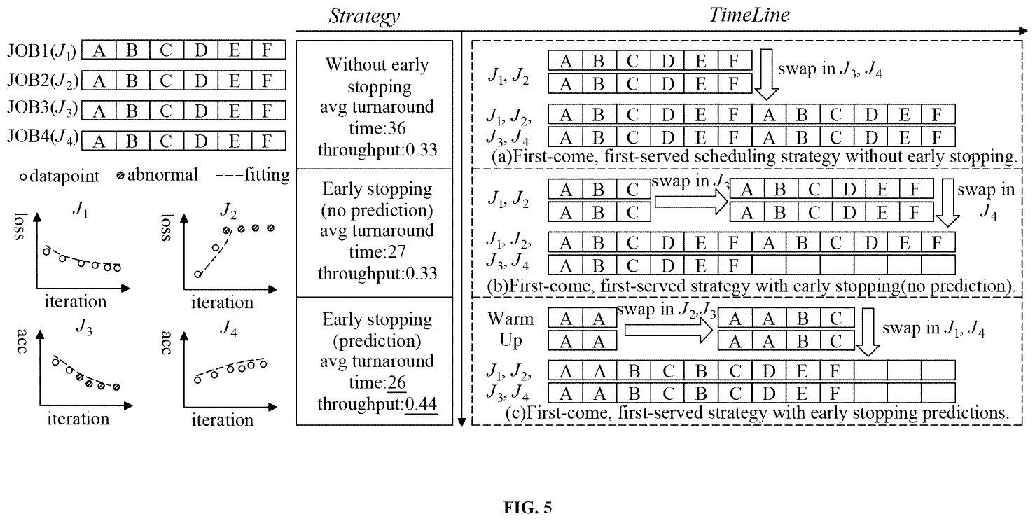

FIG. 5 shows an example of adaptive job scheduling, which shows how the dynamic job scheduler dynamically adjusts the resource allocation and job execution sequence by using the early stopping strategy with prediction according to the requirements of different jobs and the system state. In this way, the dynamic job scheduler can meet the performance requirements of different jobs while ensuring high efficiency. FIG. 5 (left) shows the precision analysis results from the profiler, and FIG. 5 (right) shows the dynamic scheduling strategies and examples. A, B, C, D, E, and F represent the training batches. Four jobs (J₁-J₄) are used as an example. The following results are obtained through testing: When the strategy (1) is adopted, J₁ and J₂ are executed first and then J₃ and J₄ are executed. The turnaround time is 36 hours, and the throughput is 0.33 jobs/hour. When the strategy (2) is adopted, after A, B, and C of J₂ are executed, J₂ is stopped early and J₃ is swapped in; after J₁ is completed, J₃ is also completed, and then J₄ is executed. In this case, the turnaround time is 27 hours, and the throughput is 0.33 jobs/hour. When the strategy (3) is adopted, some parts of J₁, J₂, J₃, and J₄ (parts A of J₁-J₄) are used for warm up, that is, pre-testing. The optimal scheduling and early stopping scheme is obtained according to the pre-testing result. To be specific, J₂ and J₃ are first executed simultaneously, and then J₂ and J₃ are stopped early at the same time (due to precision deterioration). J₁ and J₄ are then executed simultaneously. In this case, the turnaround time is 26 hours, and the throughput is 0.44 jobs/hour.

As shown in FIG. 5, according to the trend of the loss value or accuracy rate, J₂ and J₃ should be stopped as soon as possible, because continuing to run these jobs, which yield minimal gains, consumes valuable computing resources without providing significant benefits. Therefore, implementing an early stopping strategy is necessary. By comparing the turnaround time and throughput of the three strategies listed in FIG. 4, it is found that the early stopping strategy with prediction is the most effective for job scheduling.

Therefore, the optimization features of the dynamic job scheduler provided in the present disclosure include the following aspects:
(1) A near-optimal method is used to minimize the impact of padding symbols (that is, job symbol padding) on training throughput. This means the dynamic job scheduler can effectively handle input sequences of varying lengths, thereby reducing the waste of computing resources caused by padding symbols.
(2) By combining the early stopping strategy (prediction) with GPU memory performance information, a memory usage estimation model is implemented. This allows the scheduler to adaptively adjust job scheduling based on current resource usage and job requirements, optimizing memory utilization and preventing memory overflow.
(3) Multi-objective optimization is achieved. The objectives are to reduce waiting and turnaround time, increase throughput, and maintain job execution priority and fairness. This means high-priority jobs are given precedence, while the principle of first-come, first-served is upheld.
(4) These strategies effectively manage system resources and improve overall system efficiency. The intelligent scheduling strategies ensure optimal allocation and utilization of system resources among all the jobs.

### 4. Multi-Job Training Module

The premise of the multi-job training module (multi-LoRA trainer) is batch fusion, which aims to efficiently share a pre-trained model, enabling simultaneous training of multiple LoRA model fine-tuning jobs.

Batch fusion employs a parallel training iteration strategy, fusing the training data of a plurality of jobs in a same batch into a training set. This allows multiple LoRA models to share the same pre-trained model in each iteration. This approach not only enhances training efficiency but also enables modules to participate in training in parallel, rather than sequentially or separately. The multi-job training module based on batch fusion supports the parallel execution of multiple fine-tuning jobs on the same GPU. This is crucial for improving GPU resource utilization and accelerating the training process.

In this embodiment, the pre-trained model refers to a pre-trained language model, such as LLaMA-7B/13B, ChatGLM2-6B, or LLaMA2-7B/13B.

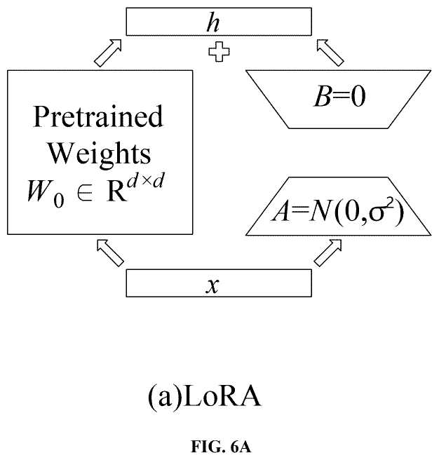

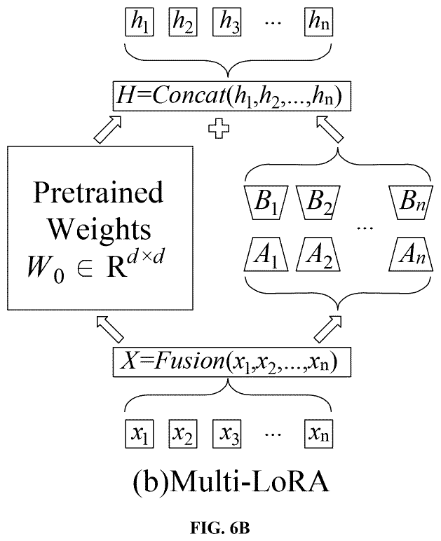

FIG. 6A shows a schematic diagram of traditional LoRA model training, and FIG. 6B shows a schematic diagram of parallel training of a plurality of LoRA models. A plurality of LoRA fine-tuning jobs J₁, . . . , and Jₙ are considered. The fine-tuning input data related to each job Jᵢ is expressed as xᵢ.

Low rank decomposition matrices of the i^{th} job (Jᵢ) is marked as Aᵢ and Bᵢ. It is worth noting that all the jobs share a same pre-training weight, represented by W₀ Fusion is used to represent the batch fusion process, and Concat represents the concatenation operation of the matrices. Fusion is similar to matrix concatenation, but the present disclosure adds extra padding tokens to ensure dimension alignment, and extra information to identify the LoRA model to which the input data belongs. Therefore, given that an input sequence of the i^{th} job is xᵢ, the output data is hᵢ. A fusion input matrix is expressed as X=Fusion (x₁, . . . , xₙ), the fusion input matrix is separately multiplied by the pre-training weight and a weight of each LoRA model, and results are added together to generate a final output H. A complete calculation formula is as follows:

$$H = Concat ( {h}_{1} , … , {h}_{n} ) = {W}_{0} X + [ Δ {W}_{1} {x}_{1} , … , Δ {W}_{n} {x}_{n} ] = {W}_{0} X + [ {B}_{1} {A}_{1} {x}_{1} , … , {B}_{n} {A}_{n} {x}_{n} ] \qquad ( 1 )$$

W₀∈R^{d×k} represents the shared pre-training weight, and d and k represent rows and columns of the matrix, ΔWᵢ=BᵢAᵢ represents a weight of an LoRA model trained in an i^{th} job, and Bᵢ∈R^{d×r}^{ᵢ} and Aᵢ∈R^{r}^{ᵢ}^{×k} are each a low rank decomposition matrix, with the rank rᵢ<<min(d, k).

The computing costs of the multi-job training module and the widely used fine-tuning library, parameter-efficient fine-tuning (PEFT), are analyzed. Supposing there are k LoRA fine-tuning jobs, each job has a different training data set. The input sequence in each iteration may be expressed as x₁, . . . , xₖ, and the fusion input matrix is X=Fusion (x₁, . . . , xₖ). When running the k LoRA fine-tuning jobs on a single GPU, the computing costs mainly include a kernel execution cost and a kernel startup cost. The above formula (1) and the following formula (2) are used:

$$h = {W}_{0} x + Δ Wx = {W}_{0} x + BAx \qquad ( 2 )$$

The main kernel execution cost involves matrix multiplication and addition operations. Because m-LoRA does not introduce additional computation, m-LoRA should have the same computing complexity as PEFT. Therefore, it is considered that the kernel execution costs of batch fusion in m-LoRA and existing PEFT methods are the same. Because the fusion input matrix X is composed of a plurality if input sequences xᵢ, r(xᵢ)<r(X). In computing operations involving matrix multiplication and addition, each operation starts a kernel. As mentioned earlier, the overhead of kernel startup is particularly significant for small kernels, that is, for low-rank matrix computation. Referring to formulas (1) and (2), the PEFT method requires starting 4k small kernels for k fine-tuning jobs, each involving three multiplication operations and one addition operation. In contrast, the batch fusion approach reduces the number of small kernels to 2k, and each operation involves only one multiplication operation. Additionally, startup of two large kernels is introduced, including one addition operation and one multiplication operation. Since the startup overhead of the kernel (that is, large kernel) for high-rank matrix computation is comparable to that of the small kernel, it can be inferred that the total kernel startup time is proportional to the number of kernels started. Therefore, the proposed batch fusion method effectively reduces the theoretical kernel startup costs and can save (k-1) Wp GB of GPU memory. According to the analysis, batch fusion can reduce the theoretical kernel startup costs by 30% to 50%, thereby optimizing GPU resource utilization.

In summary, batch fusion significantly decreases model-switching overhead. By avoiding frequent switching between different fine-tuning jobs, time and resource consumption due to model switching are reduced. Additionally, batch fusion enhances GPU resource utilization by reducing the kernel startup costs. Thus, as a key m-LoRA technology, batch fusion significantly improves the efficiency and effectiveness of multi-job fine-tuning through parallel processing, reduced switching overhead, and optimized resource utilization.

Based on the above analysis, according to the distributed pipeline-parallel LLM fine-tuning method for heterogeneous GPUs provided in this embodiment, a plurality of LoRA models are fine-tuned simultaneously based on a multi-job fine-tuning system; each LoRA model is partitioned into a plurality of parts distributed on a corresponding number of GPUs, and the GPUs are sorted; the multi-job fine-tuning system includes a job configuration module, a profiler, a dynamic job scheduler, and multi-job training modules distributed on the plurality of GPUs; each multi-job training module is configured to fine-tune a corresponding part of each LoRA model.

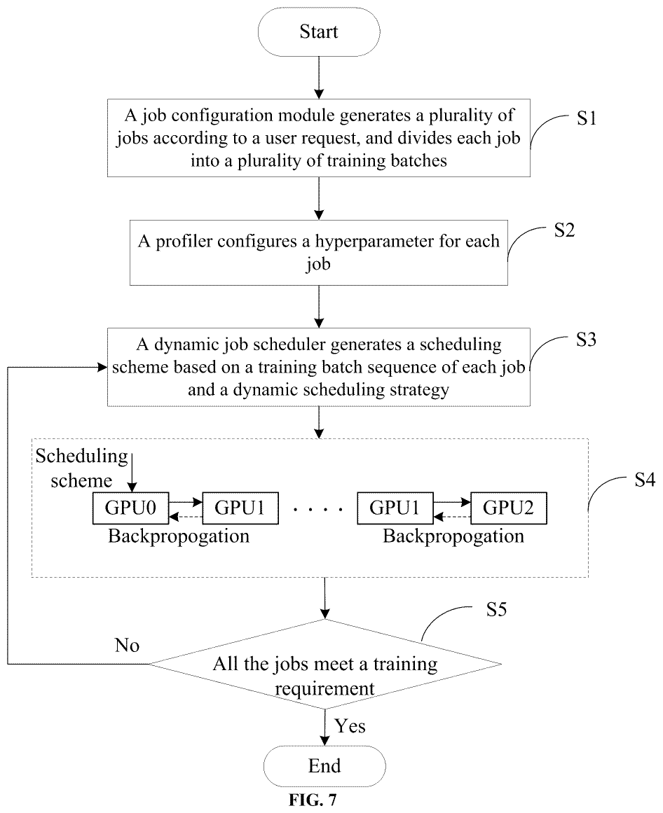

As shown in FIG. 7, the distributed pipeline-parallel LLM fine-tuning method includes the following steps:

S1: The job configuration module generates a plurality of jobs according to a user request, and divides each job into a plurality of training batches.

S2: The profiler configures a hyperparameter for each job.

During system initialization, the profiler configures an estimated basic hyperparameter for each job and distributes the hyperparameter to the m-LoRA model on each GPU for initialization.

S3: The dynamic job scheduler generates a scheduling scheme based on a training batch sequence of each job and a dynamic scheduling strategy.

According to the scheduling objective in the user request, one of the strategies (1), (2) and (3) is selected to generate the scheduling job. For example, if the scheduling objective is to minimize waiting time, reduce turnaround time, and maximize throughput, the dynamic job scheduler automatically selects the strategy (3). If the scheduling objective is to execute a series of jobs in sequence, the dynamic job scheduler automatically selects the strategy (1).

S4: The scheduling scheme is sent to a multi-job training module on a first GPU according to a positive sequence of the GPUs; the multi-job training module trains all the LoRA models according to training batches contained in the scheduling scheme; a training result is transmitted to a multi-job training module on a next GPU; the above operations are repeated until a last GPU; a loss function is determined based on a training result output by the last GPU, and the training result and the loss function are fed back to the profiler; and the loss function is backpropagated according to a reverse sequence of the GPUs, and a parameter of the corresponding part of the LoRA model on each GPU is optimized.

The specific implementation of the multi-job training module is as described above, and is not explained in detail herein.

During backpropagation, the GPU optimizes the parameter of a corresponding part of each LoRA model according to the loss function and a gradient descent optimization algorithm.

After training of the last batch of jobs is completed, the profiler optimizes and updates the hyperparameter using the gradient information received from backpropagation. in addition, the profiler performs statistical analysis on the obtained loss value, to obtain a change trend of the loss value with respect to the number of iterations. The profiler further performs statistical analysis on the obtained accuracy rate, to obtain a change trend of the accuracy rate with respect to the number of iterations. The precision analysis result includes changes in the loss value and prediction precision with respect to the number of iterations.

S5: The profiler performs precision analysis according to the training result and the loss function, and determines whether all the jobs meet a training requirement; and if yes, the program is ended; or otherwise, a precision analysis result is fed back to the dynamic job scheduler, and return to the step S3.

In this step, according to the received loss function values and training results, the profiler performs statistical analysis on the loss function values obtained after each batch of training for each job, to obtain the change trend of the loss value with respect to the number of iterations. The profiler also performs statistical analysis on the obtained accuracy rate, to obtain the change trend of the accuracy rate with respect to the number of iterations. The precision analysis result includes changes in the loss value and prediction precision with respect to the number of iterations.

The above operations are repeated for each training batch until all the LoRA models converge. When the loss function value or accuracy rate stabilizes, it is determined that the m-LoRA model has converged. The model convergence condition may alternatively be that the loss function value falls below a predefined threshold. Alternatively, whether the m-LoRA model converges may be determined according to whether the number of iterations reaches a set upper limit. When the model converges, the training objective (that is, the above scheduling objective) is achieved.

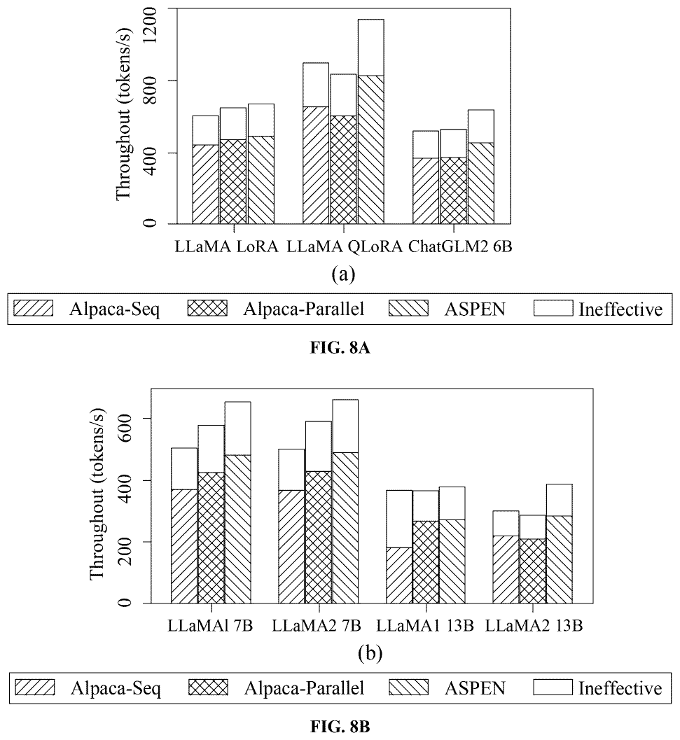

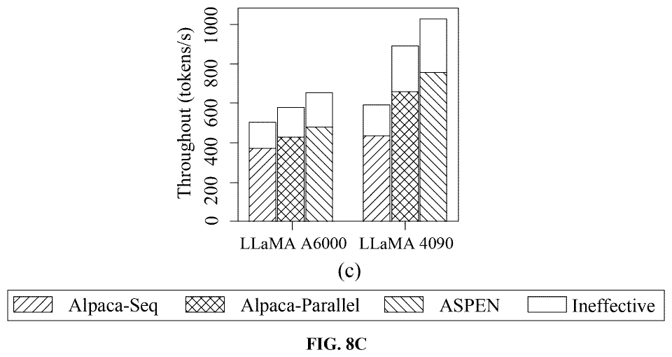

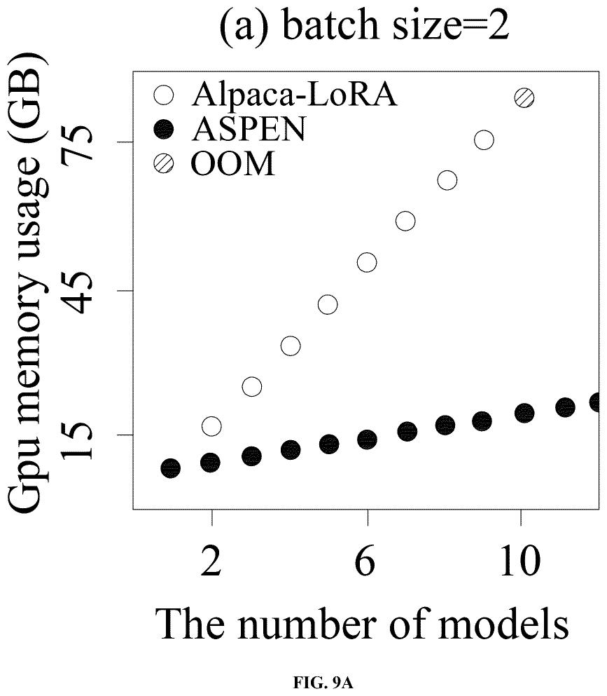

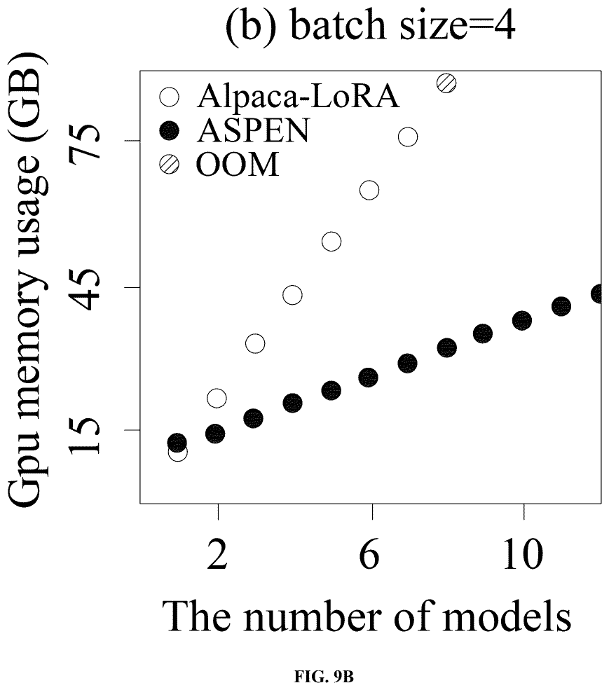

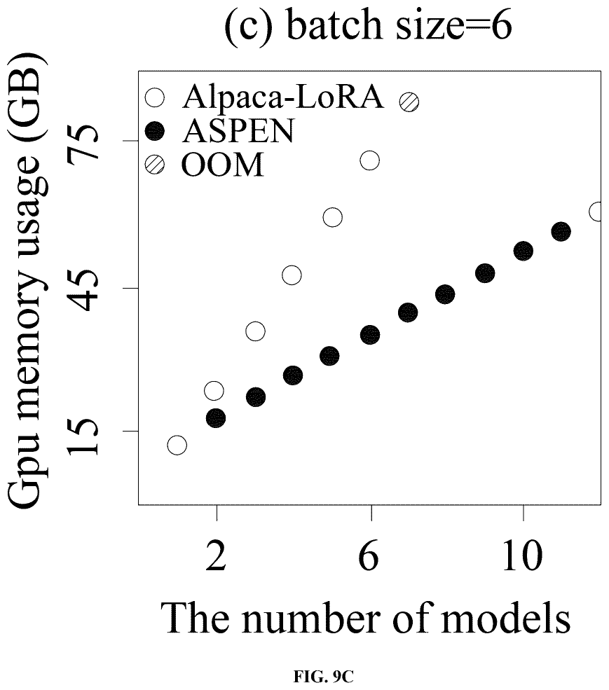

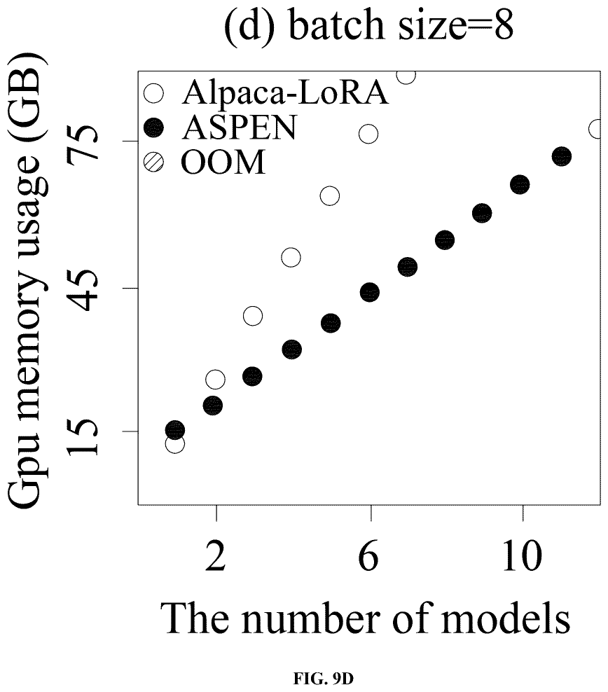

To verify the effectiveness of the fine-tuning method provided in the present disclosure, fine-tuning experiments are conducted on models such as LLaMA-7B/13B, ChatGLM2-6B, and LLAMA2-7B/13B. These experiments demonstrated that m-LoRA significantly improves the resource utilization, memory usage, and training throughput on a single GPU, as illustrated in FIGS. 8A-8C and FIGS. 9A-9D. m-LoRA exhibits substantial optimization in GPU utilization, memory usage, and training throughput within a single GPU. Compared to PEFT of Hugging Face, a leading parameter-efficient fine-tuning library, m-LoRA achieves a 53% reduction in GPU memory usage. This is particularly evident when training multiple LLaMA-7B models on an NVIDIA A100 GPU of 80 GB, as depicted in FIGS. 9A-9D. As shown in FIGS. 8A-8C, m-LoRA significantly improves both total training throughput and effective throughput compared to the baselines, achieving approximately a 17% increase in training throughput across various pre-training models compared to existing methods. The m-LoRA adaptive scheduling algorithm reduces overall turnaround time and end-to-end training delay. The experimental results demonstrate that m-LoRA achieves a 12% reduction in end-to-end training delay and a 24% reduction in overall turnaround time. The experimental results highlight the advantages of m-LoRA in terms of system efficiency and performance. As shown in FIGS. 8A-8C, the m-LoRA model, through effective utilization of computing resources, exhibits higher accuracy, and not only improves training throughput but also reduces training delay, demonstrating higher efficiency compared to existing LoRA training systems.

Therefore, the distributed pipeline-parallel LLM fine-tuning method for heterogeneous GPUs provided in the present disclosure has the following advantages:
(1) Existing memory management strategies are often simplistic and fail to fully consider memory sharing and dynamic scheduling among different jobs, leading to suboptimal resource utilization of the GPU memory. The present disclosure employs a more intelligent and flexible approach to memory management and optimization, which dynamically adjusts according to real-time job requirements and GPU memory usage, thereby enhancing GPU memory utilization and the concurrent execution capability of fine-tuning jobs.
(2) Current technologies often overlook the uneven computing power and communication overhead between different GPUs during model optimization and allocation, resulting in inefficient parallel distributed fine-tuning. The present disclosure introduces a more intelligent and flexible model partitioning and distribution strategy, combined with pipeline optimization and load balancing techniques. This approach ensures more effective utilization of computing resources in multi-machine multi-GPU environments, improving the overall efficiency of the fine-tuning process.
(3) Existing job scheduling and early stopping strategies are relatively basic and do not fully account for job priorities, dependencies, or the impact of early stopping on overall system performance. According to the present disclosure, a more intelligent and flexible job scheduling mechanism and a dynamic early stopping strategy are designed. The job execution sequence and priority can be adjusted in real-time based on job performance indicators and system load states, aiming to maximize the overall throughput and resource utilization of the system.

The present disclosure is described with reference to the flowcharts and/or block diagrams of the method, the device (system), and the computer program product according to the embodiments of the present disclosure. It should be understood that each flow and/or block in the flowchart and/or block diagram and a combination of the flow and/or block in the flowchart and/or block diagram can be implemented by computer program instructions. These computer program instructions may be provided for a general-purpose computer, a dedicated computer, an embedded processor, or a processor of another programmable data processing device to generate a machine, so that the instructions executed by a computer or a processor of another programmable data processing device generate an apparatus for implementing a specific function in one or more processes in the flowcharts and/or in one or more blocks in the block diagrams.

These computer program instructions may also be stored in a computer readable memory that can guide a computer or other programmable data processing devices to work in a specific manner, such that the instructions stored in the computer readable memory produce an article of manufacture including an instruction device, and the instruction device implements the functions specified in one or more flows of the flowchart and/or one or more blocks in the block diagram.

These computer program instructions may alternatively be loaded onto a computer or another programmable data processing device, such that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In this specification, specific embodiments are used to describe the principle and implementations of the present disclosure, and the description of the embodiments is only intended to help understand the method and core idea of the present disclosure. Meanwhile, those skilled in the art may, based on the idea of the present disclosure, make modifications with respect to the specific implementations and the application scope. Therefore, the content of this specification shall not be construed as a limitation to the present disclosure.

Those of ordinary skill in the art will understand that the embodiments described herein are intended to help readers understand the principles of the present disclosure, and it should be understood that the protection scope of the present disclosure is not limited to such special statements and embodiments. Those of ordinary skill in the art may make other various specific modifications and combinations according to the technical teachings disclosed in the present disclosure without departing from the essence of the present disclosure, and such modifications and combinations still fall within the protection scope of the present disclosure.

What is claimed is:

1. A distributed pipeline-parallel large language model (LLM) fine-tuning method for heterogeneous graphics processing units (GPUs), wherein a plurality of low-rank adaptation (LoRA) models are fine-tuned simultaneously based on a multi-job fine-tuning system; each LoRA model is partitioned into a plurality of parts distributed on a corresponding number of GPUs, and the GPUs are sorted; the multi-job fine-tuning system comprises a job configuration module, a profiler, a dynamic job scheduler, and multi-job training modules distributed on the plurality of GPUs; each multi-job training module is configured to fine-tune a corresponding part of each LoRA model; and
the distributed pipeline-parallel LLM fine-tuning method comprises the following steps:
S1: generating, by the job configuration module, a plurality of jobs according to a user request, and dividing each job into a plurality of training batches;
S2: configuring, by the profiler, a hyperparameter for each job;
S3: generating, by the dynamic job scheduler, a scheduling scheme based on a training batch sequence of each job and a dynamic scheduling strategy;
S4: sending the scheduling scheme to a multi-job training module on a first GPU according to a positive sequence of the GPUs; training, by the multi-job training module, all the LoRA models according to training batches contained in the scheduling scheme; transmitting a training result to a multi-job training module on a next GPU; repeating the above operations until a last GPU; determining a loss function based on a training result output by the last GPU, and feeding back the training result and the loss function to the profiler; and backpropagating the loss function according to a reverse sequence of the GPUs, and optimizing a parameter of the corresponding part of the LoRA model on each GPU; and
S5: performing, by the profiler, precision analysis according to the training result and the loss function, and determining whether all the jobs meet a training requirement; and if yes, ending the program; or otherwise, feeding back a precision analysis result to the dynamic job scheduler, and returning to the step S3.

2. The distributed pipeline-parallel LLM fine-tuning method for heterogeneous GPUs according to claim 1, wherein in the step S3, the dynamic job scheduler sorts jobs in each batch based on job lengths, and performs job symbol padding in the scheduling scheme on jobs with same or similar job lengths in the same batch.

3. The distributed pipeline-parallel LLM fine-tuning method for heterogeneous GPUs according to claim 1, wherein the dynamic scheduling strategy comprises:
(1) a without early stopping strategy: executing according to a job sequence;
(2) an early stopping strategy: executing according to a job sequence at the beginning;
during training, ending a job with precision deterioration in advance based on a changing trend of the precision analysis result from the profiler, and advancing a subsequent job;
(3) an early stopping strategy with prediction: first, generating the scheduling scheme based on data of more than one batch of all the jobs, executing the step S4 to perform a pre-test to obtain a prediction result, and feeding back the prediction result to the profiler; performing, by the profiler, precision analysis according to the prediction result, to generate a subsequent job scheduling scheme; and during subsequent training, ending a job with precision deterioration in advance based on a changing trend of the precision analysis result from the profiler, and advancing a subsequent job.

4. The distributed pipeline-parallel LLM fine-tuning method for heterogeneous GPUs according to claim 1, wherein in the step S4, the multi-job training module fuses training data of the plurality of jobs into a training set; and the plurality of LoRA models share one pre-training model in each iteration.

5. The distributed pipeline-parallel LLM fine-tuning method for heterogeneous GPUs according to claim 4, wherein given that an input sequence of an i^{th} job is xᵢ, output data is hᵢ, and a fusion input matrix is expressed as X=Fusion (x₁, . . . , xₙ), the fusion input matrix is separately multiplied by a pre-training weight and a weight of each LoRA model, and results are added together to generate a final output H, wherein a complete calculation formula is as follows:
$$H = Concat ( {h}_{1} , … , {h}_{n} ) = {W}_{0} X + [ Δ {W}_{1} {x}_{1} , … , Δ {W}_{n} {x}_{n} ] = {W}_{0} X + [ {B}_{1} {A}_{1} {x}_{1} , … , {B}_{n} {A}_{n} {x}_{n} ] , wherein$$
W₀∈R^{d×k} represents the shared pre-training weight, and d and k represent rows and columns of the matrix, ΔWᵢ=BᵢAᵢ represents a weight of an LoRA model trained in the i^{th} job, and Bᵢ∈R^{d×r}^{ᵢ} and Aᵢ∈R^{r}^{ᵢ}^{×k} are each a low rank decomposition matrix.

6. The distributed pipeline-parallel LLM fine-tuning method for heterogeneous GPUs according to claim 1, wherein the profiler performs statistical analysis on a loss function value obtained after each batch of training for each job, and further fits the loss function value.

7. The distributed pipeline-parallel LLM fine-tuning method for heterogeneous GPUs according to claim 1, wherein according to the training result, the profiler performs statistical analysis on and fits an accuracy rate obtained after each batch of training for each job.

8. The distributed pipeline-parallel LLM fine-tuning method for heterogeneous GPUs according to claim 2, wherein the dynamic scheduling strategy comprises:
(1) a without early stopping strategy: executing according to a job sequence;
(2) an early stopping strategy: executing according to a job sequence at the beginning; during training, ending a job with precision deterioration in advance based on a changing trend of the precision analysis result from the profiler, and advancing a subsequent job;
(3) an early stopping strategy with prediction: first, generating the scheduling scheme based on data of more than one batch of all the jobs, executing the step S4 to perform a pre-test to obtain a prediction result, and feeding back the prediction result to the profiler; performing, by the profiler, precision analysis according to the prediction result, to generate a subsequent job scheduling scheme; and during subsequent training, ending a job with precision deterioration in advance based on a changing trend of the precision analysis result from the profiler, and advancing a subsequent job.

9. The distributed pipeline-parallel LLM fine-tuning method for heterogeneous GPUs according to claim 6, wherein according to the training result, the profiler performs statistical analysis on and fits an accuracy rate obtained after each batch of training for each job.
